(19) United States
(12) Patent Application Publication
(10) Pub. No.: US 2006/0204086 A1
(43) Pub. Date: Sep. 14, 2006

(54) Compression of palettized images

(76) Inventor: Ullas Gargi, San Jose, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/076,748

(22) Filed: Mar. 10, 2005

(51) Int. Cl. G06K 9/00; G06K 9/36

(52) U.S. Cl. 382/166; 382/232

(57) ABSTRACT

In a method of compressing a palettized image having colors, the colors of the palettized image are arranged in a palette table in a hierarchical manner to form a hierarchical color palette. In addition, bit values for the colors are defined in accordance with the arrangement of the colors, such that, the bit values for substantially close colors are related and at least one of the bit values is truncated to thereby compress the palettized image.

### BACKGROUND

A digital image is typically displayed or printed in the form of a rectangular array of “pixels”. A color digital image may be represented in a computer by three arrays of binary numbers. Each array (alternatively referred to herein as an “image plane”) representing an axis of a suitable color coordinate system in accordance with the well known trichromatic theory. The color of a pixel in the digital image is defined by an associated binary number (defining one of three color components from the color coordinate system) from each array. It is noted that there are many color coordinate systems that can be used to represent the color of a pixel. These color coordinate systems include a “Red-Green-Blue” (RGB) coordinate system and a cyan-magenta-yellow (CMY) coordinate system. The former is commonly used in monitor display applications, the latter is commonly used in printing applications.

The amount of data used to represent a digital image can be extremely large. Consider, for example, a color digital image consisting of 1024×1024 pixels. If the pixels are represented in the computer by three image planes of 8-bit numbers, the digital image would occupy 3 megabytes of storage space. The large amount of data required to represent a digital image in a computer can result in significant costs that are associated both with increased storage capacity requirements, and the computing resources and time required to transmit the data to another computing device.

In efforts to reduce these costs, digital image compression techniques have been developed. These digital image compression techniques can generally be used to reduce the amount of data required to represent a digital image in a computer. These techniques can also reduce the computing costs associated with storing and transmitting digital images. There are, however, significant costs that can be incurred in using these compression techniques. For example, there can be substantial system overhead and time required to perform the compression and decompression operations.

It would therefore be desirable to have a relatively simple and inexpensive technique for compressing digital images.

### SUMMARY

A method of compressing a palettized image having colors is disclosed herein. In the method, the colors of the palettized image are arranged in a palette table in a hierarchical manner to form a hierarchical color palette. In addition, bit values for the colors are defined in accordance with the arrangement of the colors, such that, the bit values for substantially close colors are related and at least one of the bit values is truncated to thereby compress the palettized image.

### BRIEF DESCRIPTION OF THE DRAWINGS

Features of the present invention will become apparent to those skilled in the art from the following description with reference to the figures, in which:

FIG. 1 shows a block diagram of an image compression system suitable for implementing, either fully or partially, various image compression techniques according to an embodiment of the invention;

FIG. 2A illustrates a palette-indexed format according to an example of the invention;

FIG. 2B illustrates a diagram of a hierarchical palette tree depicting an example of a hierarchical arrangement of colors at different levels, according to an example of the invention;

FIG. 3 illustrates a diagram of an image containing a natural image and a synthetic image, according to an example of the invention;

FIG. 4A shows a flow diagram of an method for compressing a palettized image, according to an embodiment of the invention;

FIG. 4B shows a flow diagram showing in greater detail the steps outlined in FIG. 4A;

FIG. 4C depicts a flow diagram of a method for assigning weights for each of the colors in a hierarchical color palette, which may be employed with the method depicted in FIG. 4B, according to an embodiment of the invention;

FIG. 4D depicts a flow diagram of a method for generating rate distortion values, which may be employed with the method depicted in FIGS. 4B and 4C; and

FIG. 5 illustrates a computer system, which may be employed to perform various functions described herein, according to an embodiment of the invention.

### DETAILED DESCRIPTION

For simplicity and illustrative purposes, the present invention is described by referring mainly to an exemplary embodiment thereof. In the following description, numerous specific details are set forth in order to provide a thorough understanding of the present invention. It will be apparent however, to one of ordinary skill in the art, that the present invention may be practiced without limitation to these specific details. In other instances, well known methods and structures have not been described in detail so as not to unnecessarily obscure the present invention.

Palettized color images and video may be compressed in a relatively simple and efficient manner by arranging index values in a palette table in a hierarchical fashion as described below. In addition, the bit values associated with the colors are also arranged according to the arrangement of the colors in the palette table. In one regard, when the bit values are truncated by dropping bits, the resultant bit values point to color entries that are close to their original colors, thus enabling compression while reducing errors in the compression. The term “close” is meant to denote proximity in a color-perceptual sense.

Through quantization of the color map index values as described above, the palettized color images and video may be compressed in a lossy manner. In other words, the compressed images and video is not identical to the original and is irreversible. The images and video may also be compressed further through use of a reasonably suitable standard compression method, such as, run length encoding.

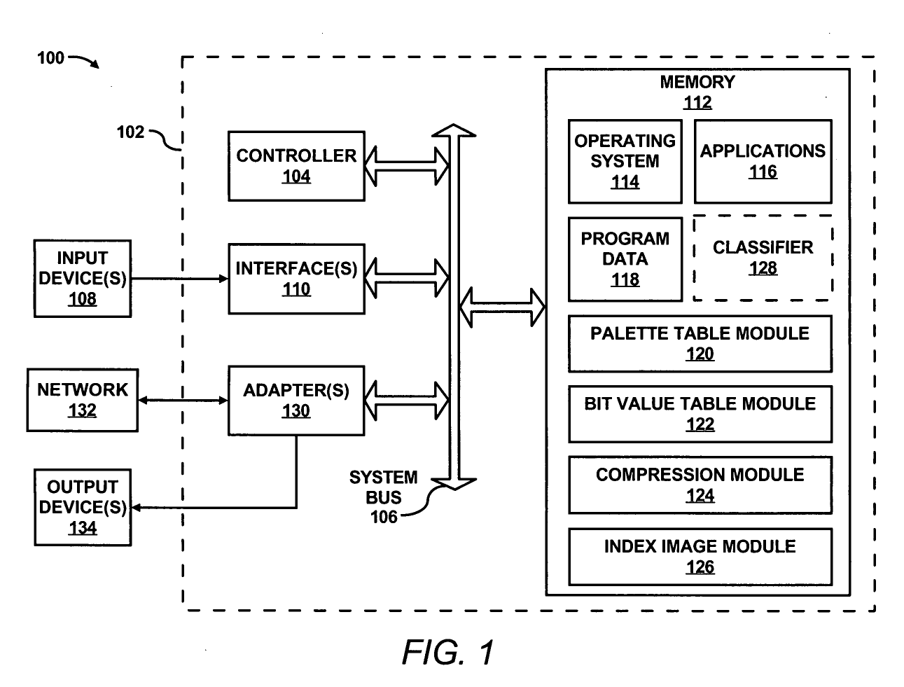

With reference first to FIG. 1, there is shown a block diagram 100 of an image compression system 102 suitable for implementing, either fully or partially, various image compression techniques described herein. It should be understood that the following description of the block diagram 100 is but one manner of a variety of different manners in which such an image compression system 102 may be configured or operated. In addition, it should be understood that the image compression system 102 may include additional components and that some of the components described may be removed and/or modified without departing from a scope of the image compression system 102. Although the image compression system 102 is depicted as comprising a computing device, various functions of the image compression system 102 may be performed by various software and/or hardware contained in a computing device. However, the following description of the image compression system 102 is set forth with the image compression system 102 comprising a computing device for purposes of simplicity.

The image compression system 102 may comprise a general computing environment and includes a controller 104 configured to control various operations of the image compression system 102. The controller 104 may comprise a microprocessor, a micro-controller, an application specific integrated circuit (ASIC), and the like. Data may be transmitted to various components of the image compression system 102 over a system bus 106 that operates to couple the various components of the image compression system 102. The system bus 106 represents any of several types of bus structures, including, for instance, a memory bus, a memory controller, a peripheral bus, an accelerated graphics port, a processor bus using any of a variety of bus architectures, and the like.

One or more input devices 108 may be employed to input information into the image compression system 102. The input devices 108 may comprise, for instance, a keyboard, a mouse, a scanner, a disk drive, removable media, flash drives, and the like. The input devices 108 may be used, for instance, to input images, frames of images or representations of the images (that is, the images in code format, which is referred to herein after as an “image” for purposes of simplicity) to the image compression system 102. The input devices 108 are connected to the controller 104 through an interface 110 that is coupled to the system bus 106. The input devices 108 may, however, be coupled by other conventional interface and bus structures, such as, parallel ports, USB ports, etc.

The controller 104 may be connected to a memory 112 through the system bus 106. Generally speaking, the memory 112 may be configured to provide storage of software, algorithms, and the like, that provide the functionality of the image compression system 102. By way of example, the memory 112 may store an operating system 114, application programs 116, program data 118, and the like. In this regard, the memory 112 may be implemented as a combination of volatile and non-volatile memory, such as DRAM, EEPROM, MRAM, flash memory, and the like. In addition, or alternatively, the memory 112 may comprise a device configured to read from and write to a removable media, such as, a floppy disk, a CD-ROM, a DVD-ROM, or other optical or magnetic media.

The memory 112 may also store modules programmed to perform various imaging functions. More particularly, the memory 112 may store a palette table module 120, a bit value table module 122, a compression module 124, and an index image module 126. In addition, the controller 104 may be configured to implement the modules 120-126 stored in the memory 112.

The palette table module 120 may receive a palette or color table (hereinafter “palette”) and an image represented as an array of index values into the palette. The controller 104 may implement the palette table module 120 to re-arrange the palette in a hierarchical manner. More particularly, the palette table module 120 is configured to cluster colors based upon their actual values, for instance, their sRGB values, for a varying number of clusters, for instance, 4, 8, 16, 32, and 64 clusters. During the clustering process, the palette table module 120 may assign each color, or palette entry, to the cluster to which the color is closest. The distance between the color and the cluster may be based upon any reasonably suitable color metric, such as, for instance, distance in the CIE Lab color space. In addition, the manner in which colors are clustered may follow a generic clustering method, such as, for instance, K-means clustering. In addition, or alternatively, the colors may be clustered according to a hierarchical clustering method, such as, for instance, agglomerative clustering.

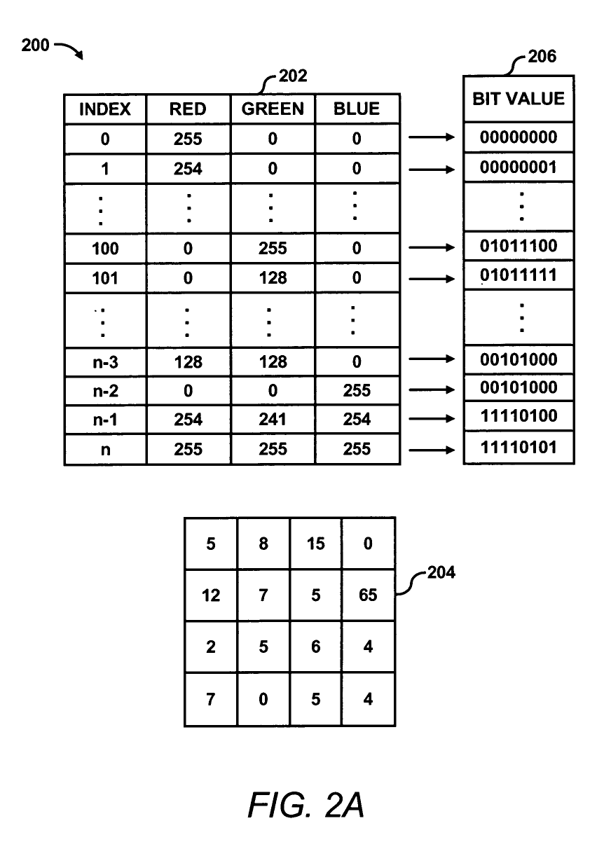

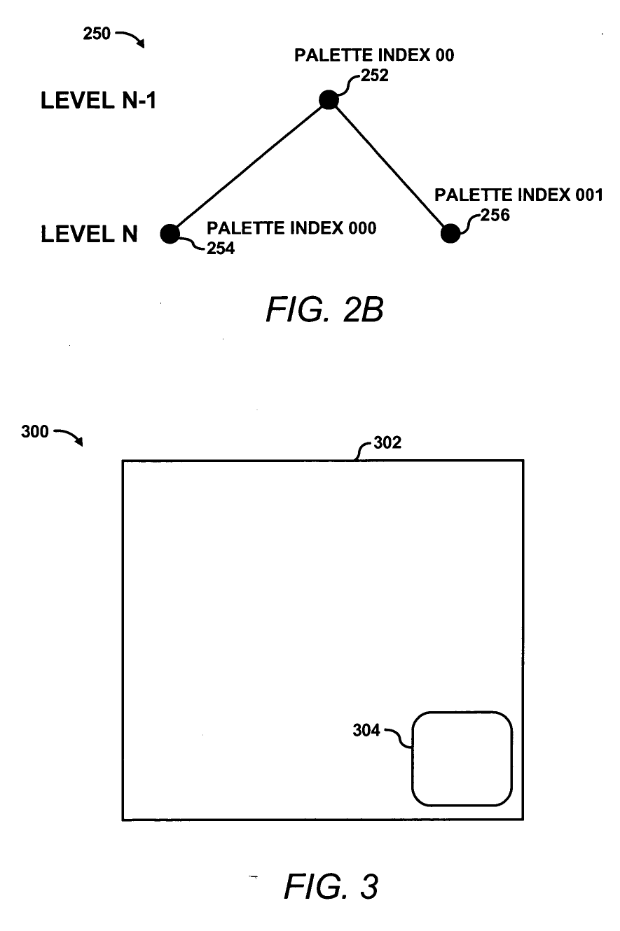

The palette table module 120 may thus generate the desired number of cluster values. The palette table module 120 may arrange the sets of cluster colors hierarchically. In this regard, a hierarchical version of the original color palette may be generated by the palette table module 120. An example of the hierarchical color palette 202, which is the hierarchical version of the original color palette, is illustrated in FIG. 2A. In the hierarchical color palette 202, the most detailed level of the hierarchy corresponds to the original colors in the palette and higher levels of the hierarchy have increasingly fewer numbers of colors. A perceptual color metric that measures the distance to its representative at the next higher level is included for each color at any point in the hierarchy.

The controller 104 may implement the palette table module 120 to select the number of colors at each level of the hierarchy. In addition, the number of colors may be chosen to correspond to different numbers of bits needed to represent entries at that level. For example, at the four color level of the hierarchy, only two bits are required to represent an entry and only four colors may be represented. As another example, at the 64 color level, 6 bits are required to represent an entry and 64 colors may be represented.

The controller 104 may implement the bit value table module 122 to assign bit values to the index values in the hierarchical color palette 202 created by the palette table module 120. More particularly, the bit value table module 122 is configured to assign bit values to each level of the hierarchical color palette 202, such that, the bit value of a color at a higher level (where there are relatively fewer colors) is a prefix of the bit values for colors beneath it in the hierarchical color palette 202 at the next lower level (where there are relatively more colors). For example, at the 4-color level, the bit value table module 122 may use the bit values 00, 01, 10 and 11 to represent the four colors and at the next level, the bit values 000 and 001 may be used to represent the sub-colors under the bit value 00, the bit values 010 and 011 may be used to represent the colors under the bit value 01, etc., as shown, for instance, in FIG. 2B.

FIG. 2B, more particularly, illustrates a diagram of a hierarchical palette tree 250 depicting an example of the hierarchical arrangement of colors at different levels as described above. As shown, at the higher level, N−1, the point 252 representing a first color has a palette index of 00. In addition, the points 254 and 256 representing sub-colors of the first color, at level N, are illustrated as having palette indexes of 000 and 001, respectively.

The hierarchical color palette 202 described above may be created without regard to the color distribution of the image itself. However, a slight modification to the formation of the hierarchical color palette 202 may include consideration of the pixel count of a color as a weight during the clustering process, such that, a color that occurs relatively often in the image affects the color of a cluster to which it is assigned to a greater extent than another color that occurs relatively less often in the image. In this case, the pixel count computation described herein below may be performed prior to the clustering process described above.

The weights for each color in the hierarchical color palette 202 may be computed based upon the pixel count and, optionally, the spatial distribution of the color. The weights may be computed, for instance, through a scanning of the image. In this regard, the pixel count may be obtained through the counting of the number of times a particular color in the original palette entry occurs in the palettized image as obtained during the scan of the image. The counts for colors in levels above the original colors may be obtained by merging the counts for related sub-colors.

The spatial distribution function measures the compactness of the occurrence of a particular color and hence its contribution to visual quality. Generally speaking, a color that is loosely distributed throughout the image in low densities with a total of N pixels is less visually important than one that occurs in a compact N-pixel arrangement at the center of the image. Similarly, a color that forms a hard edge is more visually important than one that forms a soft edge. In any regard, a measure of spatial compactness may be obtained for each original color, for example, by binned horizontal and vertical projections. Spatial distributions for colors in higher levels of the hierarchical color palette 202 may be obtained by weighted averages of the related sub-colors. The weighted averages may include, for instance, the pixel counts of the colors as described above.

Rate distortion values may be generated that indicate the level of distortion that would occur in the image if a color were to be replaced by its parent color in the next higher level in the hierarchical color palette 202. In addition, the rate distortion values may be assigned to each link between a color and its parent color. The rate distortion values may further, for instance, be represented in the form of tables or curves. The rate distortion values may be generated based upon the total number and spatial distributions of each original color, and therefore, of each color in the hierarchical color palette 202, as well as the perceptual distance between any color and its parent or representative at the next higher level obtained during the clustering process. By way of example, if a color C, which occurs N times in the image were to be replaced with its representative color at the next higher level C′ (where C′ has one bit less in its index than C), then a measure of the error would be N*|C−C′|, where |C−C′| is a distance in color perceptual space, such as, CIE Lab. This equation may be modified to include spatial compactness in situations where the equation is computed. In addition, the gain in compression would be N bits minus any special code needed to indicate the change.

In any regard, the rate distortion values may be employed to generally determine acceptable levels of compression. More particularly, for instance, the levels of distortion determined through use of the rate distortion values may dictate which of the colors may be replaced by their parent colors. In this respect, if it is determined that a greater number of colors may be replaced by their parent colors while remaining within a predefined level of distortion, an image file containing those colors may be compressed to a greater extent as compared to an image file containing colors that when replaced by their parent colors exceed the predefined level of distortion. A measure of the distortion values for each of the colors in the hierarchical color palette 202 may thus be constructed. In addition, these distortion values, which indicate the level of distortion a color will undergo if that color were replaced by its parent color in the hierarchical color palette 202, may be used during compression of the image as described in greater detail herein below.

The preceding operations may be performed offline. That is, the preceding operations may be performed when the image is not being transmitted. In addition, the controller 104 may implement the compression module 124 to perform compression when the image is being transmitted or is required to be compressed. In one respect, the compression module 124 may compress the palettized image through one or more compression techniques using the rate distortion values obtained above.

The controller 104 may also transmit special codes indicating that the bits have been truncated from the index values in the image. For instance, if the image was represented using 256 colors using an 8-bit index for each pixel and after truncation the image is represented using 64 colors with 6 bits for each pixel, a special code indicating that the image is now represented using 6 bits per pixel may be inserted into the bitstream to indicate this change. These special codes may be inserted anywhere in the bitstream, and are thus not limited to the image boundaries.

In a first example, the compression module 124 is configured to compress the image by truncating the bit values, to thereby reduce the memory requirements of the bit values. In this example, the compression module 124 truncates bits from palette color indices, effectively replacing colors by their shorter-indexed parent colors in the hierarchical color palette 202. In one respect, the bit values may be truncated in order to meet bitrate requirements imposed by the transmission channel. In addition, the compression module 124 may replace colors with their parents that have the lowest rate distortion values first. After replacing a color with its parent, the compression module 124 computes the new bitrate, for instance, the number of bits required to represent the image or the remaining parts of the image, and the distortion introduced. Both of these values may be pre-computed and may be readily available in the hierarchical color palette 202 due to the offline processing steps described above. The compression module 124 may continue replacing colors with their parent colors in the hierarchical color palette 202 until the desired bitrate is achieved. Thus, it may replace the same number of bits from each of the pixels or the compression module 124 may truncate one or more of the pixels to differing levels.

In another example, certain of the bit values may not be truncated at all or to the same extent as other bit values, for instance, in situations where truncation of those bit values would produce a relatively high error. The level of error obtained through truncation of the bit values representing some of the colors, or replacing the colors with their respective parent colors, are determined through use of the rate distortion values as described herein above. By way of example, if the palette table contains 254 entries covering the yellow-green color region and a single entry for a blue color, quantization of the bit value for that blue color may yield a significant error if its pixel count is sufficiently high. More particularly, truncation of the bit value of that blue color may cause pixels with that index value to have a yellow-green color instead of the blue color. In this case, the distortion value for that blue color will be substantially higher than other original palette colors. As such, that blue color will not have its index value truncated until other lower distortion replacements have been effected. In this respect, the blue color may be substantially protected to thereby reduce the possibility of the error due to a truncation of its bit value.

This protection may be effectuated in two ways. For instance, if the hierarchical palette has been properly constructed giving due regard to such perceptual color distances between palette colors, then there will be a blue color representative at many levels of the hierarchical color palette 202, such that even truncation will not result in the blue color being replaced with a yellow-green color. In another instance, if there is no blue color at any higher level of the hierarchical palette tree above the original color level, then blue pixel values will be represented using the original index value and number of bits, even after other colors have been truncated to fewer bits.

Various standard techniques for representing special codes to represent out of band information, such as, for instance, a change in level, exceptions, etc., may be employed to represent the special codes. By way of example, certain pixel values, such as, for instance, 00000000 and 1111111, may be reserved to represent such codes instead of actual color values. In one respect, these special codes may optionally be inserted only on raster line boundaries to make it easier for an image decoder to parse the bitstream, for instance.

As another example, however, if the compression module 124 determines that the number of pixels having the blue color is relatively small, with a relatively high spatial distribution between the blue color pixels, the compression module 124 may proceed with truncating the bit value for that blue color. On the other hand, even if the number of pixels having the blue color is relatively small, but have a relatively small spatial distribution between the blue color pixels, the compression module 124 may protect that bit value as previously stated.

The compression module 124 may also operate to further compress the image through conventional lossless compression techniques, such as arithmetic coding. In one example, the compression module 124 may employ a lossless compression technique to the truncated bit values to thereby further compress the image. The compression module 124 may also operate to improve visual quality when truncating bits, for example by performing spatial dithering of colors in the image to avoid false contouring.

The compression module 124 may also employ the above-described compression-by-truncation procedure only on particular areas of the image. This example may be performed on images containing, for instance, a first or natural image 302, such as, a photograph, and a synthetic overlaid image 304, such as, a television caption or logo, as shown in FIG. 3. More particularly, it may be beneficial in many instances to compress the natural image 302 using some other method, such as JPEG compression and to compress the overlaid synthetic palettized portion 304 using the compression-by-truncation method described above, to thereby preserve the natural image 302 while compressing the image 300.

In this example, and as shown in FIG. 1, the memory 112 may optionally include a classifier 128, shown in dashed lines. The controller 104 may implement the classifier 128 to distinguish between a natural image and a synthetic image in a block by block basis. The classifier 128 may also classify each incoming block of an image frame as comprising a natural image or a synthetic image. The compression module 124 may apply a different compression scheme to those blocks classified as natural images and those blocks classified as synthetic images. For example, the classifier 128 may classify blocks with high color variance as natural images and blocks with only one or two distinct colors as synthetic images. The synthetic images as a whole may then be palettized and the compression-by-truncation technique described above may be applied only to those blocks classified as synthetic images.

The controller 104 may implement the index image module 126 to display the image based upon the image data. More particularly, the index image module 126 may create an index image (element 204, FIG. 2A) that contains a reference to an index value for each pixel in the image. The index image module 126 may therefore be implemented to determine the index values for either or both of the image or a compressed form of the image, such that the image may be displayed according to the values contained in the palette table.

The image data, including compressed image data and in certain instances, the original image data, may be transmitted outside of the image compression system 102 through one or more adapters 130. In a first example, the image data may be transmitted to a network 132, such as, an internal network, an external network (the Internet), etc. In a second example, the image data may be outputted to one or more output devices 134, such as, displays, printers, facsimile machines, etc.

The modules 120-126 may be implemented by the controller 104 to also compress streaming video, where each frame of the video, or blocks thereof, is a palettized image. More particularly, at least part of each frame of the video may be represented as a separate palettized image with its own distinct hierarchical palette as described above. In this regard, at least part of each frame of the video may be prepared for compression through the truncation schemes as also described above. The palettization of at least part of each frame may be performed when the image is not being transmitted. In addition, or alternatively, one or more consecutive frames may share the same palette if their content is sufficiently similar.

In this example, the palette table module 120 may update the palette table whenever necessary by a special code in the bitstream. For instance, when the streaming video is being transmitted, the rate of the bitstream may be dynamically adjusted based on available bandwidth, congestion, etc.

With particular reference back to FIG. 2A, there is illustrated a palette-index format, generally denoted as format 200, according to an example of the invention. It should be readily apparent that the palette-index format 200 depicted in FIG. 2A represents a generalized illustration and that other elements may be added or existing elements may be removed or modified without departing from a scope of the palette-index format 200, as described below.

The palette-index format 200 includes a hierarchical color palette 202 and an index image 204. Also shown in FIG. 2A is a bit value table 206 that correspond to the index numbers listed in the hierarchical color palette 202. It should be understood that the values denoted in the hierarchical color palette 202, the index image 204, and the bit value table 206 have been selected arbitrarily for purposes of illustration only and are not meant to limit the palette-index format 200 in any respect.

As shown in FIG. 2A, the hierarchical color palette 202 provides for a translation between an index value and its associated red, green, and blue intensity values. The index image 204 contains a reference to an index value for each pixel in an image. The index values listed in the index image 204, therefore, denote the intensity levels for each of the colors listed in the hierarchical color palette 202 for each of the pixels.

With particular reference to the hierarchical color palette 202, the index values are illustrated as including index value 0 through index value n, where n is an integer greater than zero. In addition, the vertical ellipses (“ . . . ”) between various rows in the palette table 202 indicate that a portion of the vertical pattern of values in the palette table 202 is not shown in FIG. 2A. The intensity values for each of the colors are indicated as ranging between 0 and 255. Therefore, a total of 256 colors may be displayed simultaneously according to the hierarchical color palette 202. However, the hierarchical color palette 202 shown in FIG. 2A is not required to have all 256 colors, for instance, in the event that a received image contains fewer than 256 colors.

In any regard, the intensity levels of the colors denoted in the hierarchical color palette 202 are illustrated as being arranged in a hierarchical fashion. That is, the perceptually important colors, in this example, red, green, and blue, are each arranged such that variations in colors from each of these perceptually important colors are arranged in a hierarchical manner with respect to each of the perceptually important colors. The perceptually important colors in this example may correspond to the number of clusters described above. Thus, for instance, the index value 0 denotes the perceptually important color red at its highest intensity level. The index value 1 denotes a slight variation of the red and is at the second highest intensity level. The index values that follow, for instance index values 2-49, may denote variations or sub-colors of the color red that are within a certain distance in the color space from the red color denoted at index value 0. The “closeness” between the colors denoted by the index values 2-49 in this example may also be determined through other conventional methods. In addition, the variations of the color red may be arranged such that those colors that are the closest to the color red denoted in index value 0 is closest to the index value 0 in the hierarchical color palette 202.

In the example shown in FIG. 2A, the next perceptually important color depicted is green and is denoted by the index value 100. In a similar fashion to the color red, variations of the color green are listed following the index value 100. Thus, for instance, the index values that follow, for instance index values 101-119, may denote variations of the color green that are within a certain distance in the color space from the green color denoted at index value 100.

The process of determining the perceptually important colors and arranging variations of the perceptually important colors may be repeated for each of the perceptually important colors. In this regard, the hierarchical color palette 202 may include a hierarchical listing of all of the colors arranged according to their “closeness” to respective ones of the perceptually important colors.

In certain instances, a perceptually important color may include a single entry in the palette table 202, such as, the index value n−2 having the highest intensity blue color. As described above, the bit value for the index value n−2 may be protected in certain instances to substantially prevent the blue color from changing due to truncation of the bit value.

The bit value table 206 depicts the bit values associated with the index values or colors listed in the palette table 202. As shown in the bit value table 206, the bit values are also arranged in an ordered fashion according to the number of perceptually important colors or cluster colors contained in the hierarchical color palette 202 and the variations of those colors arranged in the hierarchical color palette 202. In addition, the vertical ellipses (“ . . . ”) between various rows in the bit value table 206 indicate that a portion of the vertical pattern of values in the bit value table 206 is not shown in FIG. 2A. By way of example, if there are eight perceptually important colors or cluster colors, the first three bits of each of the bit values may correspond to a particular perceptually important color or cluster color. More particularly, for instance, a first color may be assigned 000, a second color may be assigned 001, a third color may be assigned 010, and so forth up to 111 for the eighth color. In addition, sub-colors may be assigned related bit values, such as, 0001 and 00010 for the first color 000, 0101 and 0100 for the second color, etc., as described above.

Although the hierarchical color palette 202 has been depicted as including three colors, additional colors may be included in the hierarchical color palette 202 without departing from a scope of the palette-index format 200. In addition, although the bit values 206 have been denoted as including eight bits, any reasonably suitable number of bits may be used to denote the index values while remaining within a scope of the palette index format 200 illustrated in FIG. 2A.

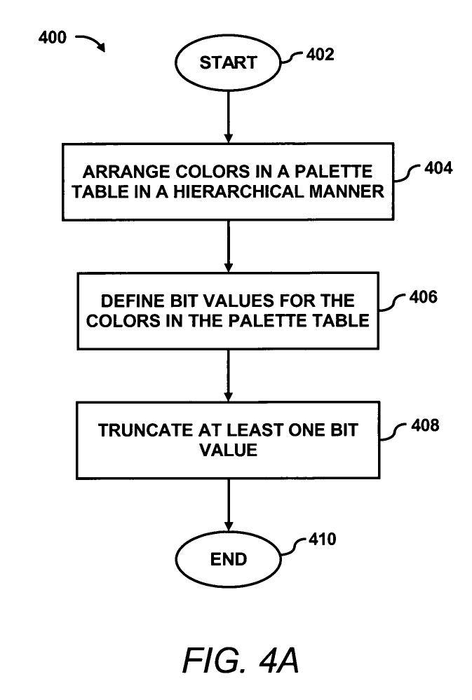

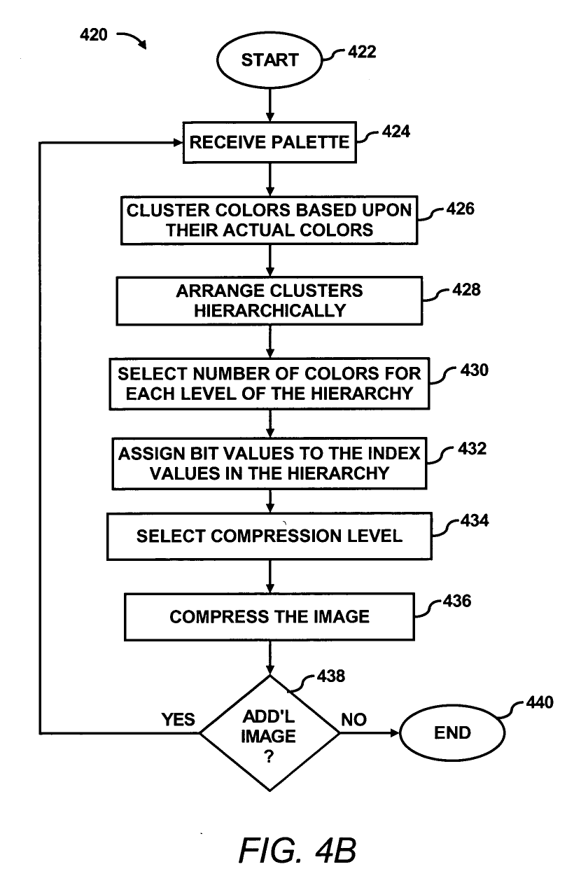

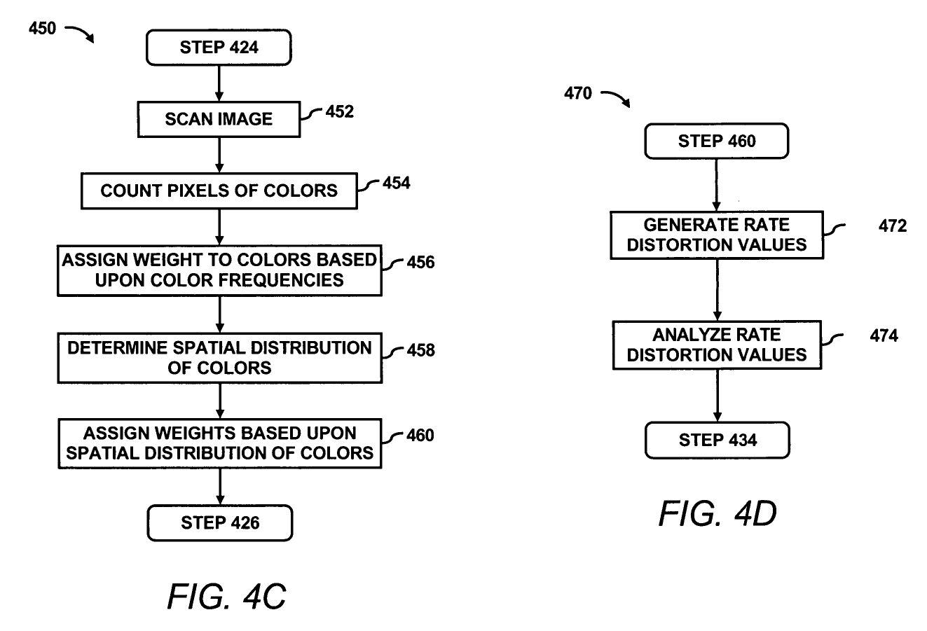

Referring now to FIG. 4A, there is shown a flow diagram of a method 400 for compressing a palettized image, according to an example. It is to be understood that the following description of the method 400 is but one manner of a variety of different manners in which the palettized image may be compressed. It should also be apparent to those of ordinary skill in the art that the method 400 represents a generalized illustration and that other steps may be added or existing steps may be removed or modified without departing from a scope of the method 400. The description of the method 400 is made with reference to the block diagram 100 illustrated in FIG. 1, and thus makes reference to the elements cited therein.

The method 400 may be initiated under a variety of conditions at step 402. For instance, the method 400 may be automatically or manually initiated. In the former case, the method 400 may be performed, for instance, in response to receipt of a palettized image to be compressed, in response to an instruction from a computing device, etc. In the latter case, a user may manually initiate the method 400.

At step 404, the colors of the palettized image may be arranged in a palette table in a hierarchical manner as described above. In addition, bit values for the colors in the palette table may be defined at step 406 and at least one of the bit values may be truncated at step 408 to thereby compress the palettized image. Some of the steps outlined in the method 400 are described in greater detail with respect to FIG. 4B.

FIG. 4B shows a flow diagram of a method 420 for compressing a palettized image and is a more detailed version of the method 400. As such, the method 420 may be initiated under a variety of conditions at step 422, as described above with respect to step 402.

In addition, the method 420 may be initiated through receipt of a palette or color table (hereinafter “palette”) at step 424. The palette may be received, for instance, from an input device 108 or over the network 132. In any event, step 424 may be considered optional because the palette may have previously been received or the method 420 may be performed on a palette stored in the memory 112.

At step 426, the colors in the palette may be arranged into a number of clusters, for instance, 4, 8, 16, etc., clusters, based upon their actual values. More particularly, the colors may be assigned to the cluster to which the colors are closest according to any reasonably suitable metric, such as, distance in the CIE Lab color space. In addition, at step 428, the clusters may be arranged in a hierarchical manner to form a hierarchical color palette 202 as shown, for instance, in FIG. 2A. In the hierarchical color palette 202, the most detailed level of the hierarchy corresponds to the colors in the original palette and higher levels of the hierarchy have increasingly fewer numbers of colors.

At step 430, the number of colors for each level of the hierarchical color palette 202 may be selected. More particularly, the number of colors for each level may be chosen to correspond to different numbers of bits needed to represent entries at that level. For instance, at the four color level of the hierarchy, only two bits are required to represent an entry and only four colors may be represented; whereas, at the 64 color level, 6 bits are required to represent an entry and 64 colors may be represented.

At step 432, bit values may be assigned to the index values in the hierarchical color palette 202. More particularly, bit values may be assigned to each level of the hierarchical color palette 202, such that, the bit value of a color at a higher level is a prefix of the bit values for colors beneath it in the hierarchical color palette 202 at the next lower level. Examples of manners in which the bit values may be assigned are described in greater detail herein above.

Steps 424-432 may be performed offline, when the image or data pertaining to the image is not being transmitted. In addition, the following steps 434 and 436 may be performed prior to or during transmission of the image or data pertaining to the image.

More particularly, at step 434, the level of compression to be applied to the bit values may be selected. In other words, the number of bits to truncate from the bit values may be determined at step 434. In addition, the level of compression to be applied may be based upon, for instance, available bandwidth, storage space requirements, desired image quality, etc. The level of compression may also be based upon rate distortion values that indicate the level of distortion that would occur in the image if a color were to be replaced by its parent color in the next higher level in the hierarchical color palette 202, as described in greater detail herein below with respect to the method 470 depicted in FIG. 4D.

In any respect, the palettized image may be compressed at step 436 based upon the compression level selected at step 434.

In a first example, the palettized image may be compressed by truncating bits from the bit values representing the various colors listed in the hierarchical color palette 202. In this example, the number of bits truncated from the bit values may be based upon the level of compression determined at step 434. A greater number of bits may thus be truncated from the bit values for increased levels of compression. In addition, the number of bits truncated from certain of the bit values may vary from the number of bits truncated for other bit values. In this case, certain ones of the bit values may not be truncated at all or they may be truncated to a lesser degree as compared with the other bit values. The level to which the bit values may be truncated may be based upon an investigation of how close, for instance, in the color space, the neighboring colors are to the colors associated with the bit values.

By way of example, if the palette table contains 254 entries covering the yellow-green color space and a single entry for a blue color space, quantization of the bit value for that blue color may yield a significant error. More particularly, truncation of the bit value of that blue color may cause pixels with that index value to have a yellow-green color instead of the blue color. In this case, the bit value for that blue color may be substantially protected, such that, it either remains in tact or that it undergoes a lesser degree of truncation. In this respect, the blue color may be maintained in the image to thereby reduce the possibility of the error due to a truncation of its bit value.

On the other hand, if the number of pixels having the blue color is relatively small and relatively spaced apart from one another in the image, the bit values for the blue color may still be truncated to the same level consistent with the other bit values. As a further alternative, even if the number of pixels having the blue color is relatively small, if they are located in substantially close proximity to each other, the bit values for these pixels may still be protected as described above.

In any regard, the compression performed at step 436 may include an additional compression step such that the truncated bit values may be compressed to a further extent. In this regard, the truncated bit values may be compressed through conventional lossless compression techniques, such as, JPEG.

With reference back to step 434, the level of compression applied to an image may substantially be varied for different sections of the image. By way of example, if the image contains a natural image 302 (FIG. 3) and a synthetic image 304, different levels of compression may be selected for each of these images. In one respect, a lossless compression technique may be selected for the natural image 302, while the lossy compression technique described herein may be selected for the synthetic image 304. In addition, the selected compression techniques for the natural image 302 and the synthetic image 304 may be applied to compress the image 300 at step 436.

Following compression of the image 300, it may be determined as to whether the method 420 is to continue. More particularly, at step 438, it may be determined whether additional images are to be compressed. Additional images may be compressed, for instance, in the event that the method 420 is implemented to compress streaming video. In this event, the method 420 may be implemented for each frame of the streaming video.

If, however, it is determined that the method 420 is to be discontinued, the method 420 may end as indicated at step 440.

The method 420 may include additional operations to further refine certain of the steps contained in method 420. In a first example, reference is made to FIG. 4C, which depicts a flow diagram of a method 450 for assigning weights for each of the colors in the hierarchical color palette 202. As shown, the steps 452-460 contained in the method 450 may be performed between steps 424 and 426 in the method 420 shown in FIG. 4B. Thus, for instance, the method 450 may be performed to assign weights to the colors prior to the colors being clustered and arranged hierarchically.

With particular reference back to FIG. 4C, at step 452, the image received at step 424 may be scanned. At step 454, the pixels of the various colors contained in the scanned image may be counted, for instance, by counting the number of times a particular color in the original palette entry occurs in the palettized image. The counts for colors in levels above the original colors may be obtained by merging the counts for related sub-colors. In addition, weights may be assigned to the colors based upon the pixel counts for each of the colors, as indicated at step 456.

The method 450 may also include the optional steps of assigning weights to the colors based upon their spatial distributions. If the spatial distributions of the colors are to be factored in assigning weights to the colors, the spatial distributions of the colors may be determined as indicated at step 458. The spatial distributions may be determined, for instance, through binned horizontal and vertical projections. In addition, the spatial distributions for colors in higher levels of the hierarchical color palette 202 may be obtained by weighted averages of the related sub-colors. Based upon the respective spatial distributions, various weights may be assigned to the colors, as indicated at step 460.

The weights assigned to each color at step 456 and optionally at step 460, may be used as considerations at step 426 in clustering the colors. For instance, a color that has a relatively high pixel count may affect the color of the cluster to which it is assigned to a greater extent than another color that has a relatively low pixel count.

In a second example of an additional operation that may be performed to further refine certain of the steps contained in method 420, reference is made to FIG. 4D, which depicts a flow diagram of a method 470 for generating rate distortion values. As shown, steps 472 and 474 contained in the method 470 may be performed following step 460 in the method 450 shown in FIG. 4C and prior to step 436 in the method 420 shown in FIG. 4B. Thus, for instance, the method 470 may be performed to determine acceptable levels of compression to be selected at step 434.

With particular reference to FIG. 4D, at step 472, rate distortion values may be generated that indicate the level of distortion that would occur in the image if a color were to be replaced by its parent color in the next higher level in the hierarchical color palette 202. The rate distortion values may be generated based upon the total count and spatial distributions of each original color as determined through, for instance, implementation of the method 450. The perceptual distance between any color and its parent or representative at the next higher level obtained during the clustering process (step 426) may also be used to generate the rate distortion values.

The rate distortion values generated at step 472 may be analyzed to determine the level of distortion caused by replacement of a color by a color parent at step 474. In addition, the analysis performed at step 474 may be employed at step 434 to select the level of compression to be applied on the image. More particularly, for instance, the levels of distortion determined through use of the rate distortion values may dictate which of the colors may be replaced by their parent colors. In other words, the distortion levels may dictate which of the bit values may be truncated and to what level to set the level of compression at step 434.

In a third example of an additional operation that may be performed to further refine certain of the steps contained in method 420, the method 420 may be employed on a section of the image instead of the entire image. For instance, the method 420 may be implemented to compress part of the image whereas another compression technique may be performed on other parts of the image. By way of example, the method 420 may be implemented to compress a synthetic image, such as, an image laid over a natural image, as described in greater detail hereinabove.

Through implementation of the methods 400, 420, and optionally methods 450 and 470, images and video may be compressed in a relatively simple and efficient manner. In this regard, only a relatively small amount of processing power may be required to adequately compress the images and video, thereby reducing the time and costs associated with the compression operation.

Some or all of the operations illustrated in the methods 400, 420, 450, 470 may be contained as a utility, program, or a subprogram, in any desired computer accessible medium. In addition, the methods 400, 420, 450, 470 may be embodied by a computer program, which may exist in a variety of forms both active and inactive. For example, they can exist as software program(s) comprised of program instructions in source code, object code, executable code or other formats. Any of the above can be embodied on a computer readable medium, which include storage devices and signals, in compressed or uncompressed form.

Exemplary computer readable storage devices include conventional computer system RAM, ROM, EPROM, EEPROM, and magnetic or optical disks or tapes. Exemplary computer readable signals, whether modulated using a carrier or not, are signals that a computer system hosting or running the computer program can be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that any electronic device capable of executing the above-described functions may perform those functions enumerated above.

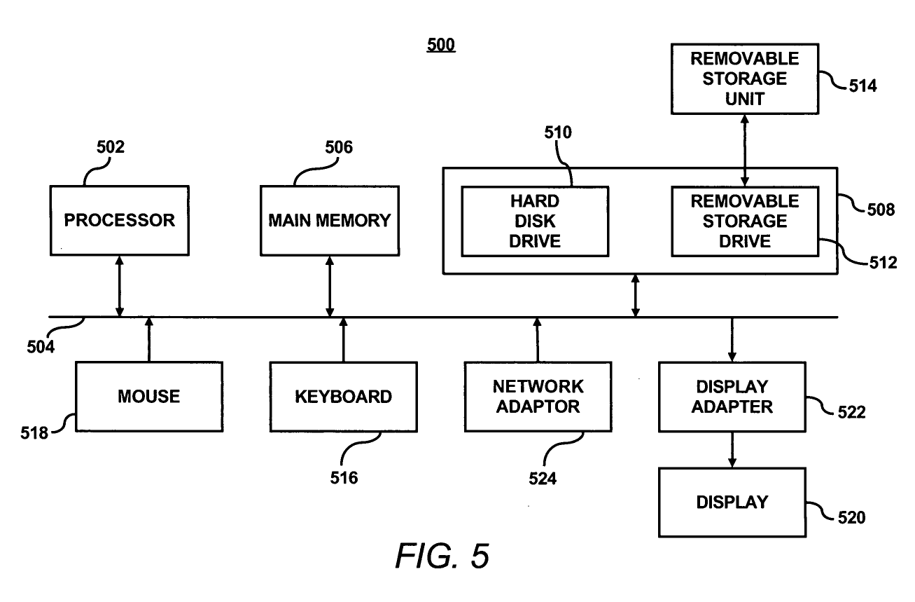

FIG. 5 illustrates a computer system 500, which may be employed to perform various functions described herein. The computer system 500 may include, for example, the controller 104. In this respect, the computer system 500 may be used as a platform for executing one or more of the functions described herein above with respect to the various components of the image compression system 102.

The computer system 500 includes one or more controllers and a processor 502. The processor 502 may be used to execute some or all of the steps described in the methods 400, 420, 450, 470. Commands and data from the processor 502 are communicated over a communication bus 504. The computer system 500 also includes a main memory 506, such as a random access memory (RAM), where the program code for, for instance, the controller 104, may be executed during runtime, and a secondary memory 508. The secondary memory 508 includes, for example, one or more hard disk drives 510 and/or a removable storage drive 512, representing a floppy diskette drive, a magnetic tape drive, a compact disk drive, etc., where a copy of the program code for the image compression system 102 may be stored.

The removable storage drive 510 reads from and/or writes to a removable storage unit 514 in a well-known manner. User input and output devices may include a keyboard 516, a mouse 518, and a display 520. A display adaptor 522 may interface with the communication bus 504 and the display 520 and may receive display data from the processor 502 and convert the display data into display commands for the display 520. In addition, the processor 502 may communicate over a network, for instance, the Internet, LAN, etc., through a network adaptor 524.

It will be apparent to one of ordinary skill in the art that other known electronic components may be added or substituted in the computer system 500. In addition, the computer system 500 may include a system board or blade used in a rack in a data center, a conventional “white box” server or other computing device, etc. Also, one or more of the components in FIG. 5 may be optional (for instance, user input devices, secondary memory, etc.).

What has been described and illustrated herein is a preferred embodiment of the invention along with some of its variations. The terms, descriptions and figures used herein are set forth by way of illustration only and are not meant as limitations. Those skilled in the art will recognize that many variations are possible within the spirit and scope of the invention, which is intended to be defined by the following claims—and their equivalents—in which all terms are meant in their broadest reasonable sense unless otherwise indicated.

What is claimed is:

1. A method of compressing a palettized image having colors, said method comprising:
arranging the colors of the palettized image in a palette table in a hierarchical manner to form a hierarchical color palette;
defining bit values for the colors in accordance with the arrangement of the colors, such that, the bit values for substantially close colors are related; and
truncating at least one of the bit values to thereby compress the palettized image.

2. The method according to claim 1, wherein the step of arranging the colors further comprises arranging the colors into a plurality of clusters according to the proximities of the colors to the plurality of clusters and arranging the clusters in a hierarchical manner.

3. The method according to claim 2, wherein the step of arranging the colors in a hierarchical manner further comprises arranging the colors such that colors in the lower levels of the hierarchical color palette have a greater number of colors as compared to colors in the higher levels of the hierarchical color palette.

4. The method according to claim 2, further comprising:
counting pixels of the colors contained in the palettized image;
assigning weights to the colors based upon the number of pixels counted for the colors; and
wherein the step of arranging the colors into a plurality of clusters further comprises selecting the clusters based upon the assigned weights of the colors.

5. The method according to claim 2, further comprising:
determining the spatial distribution of the colors in the palettized image;
assigning weights to the colors based upon the spatial distributions of the colors; and
wherein the step of arranging the colors into a plurality of clusters further comprises selecting the clusters based upon the assigned weights of the colors.

6. The method according to claim 1, further comprising:
selecting a number of colors for each level of the hierarchical color palette to correspond to different numbers of bits used to represent entries at each level of the hierarchical color palette.

7. The method according to claim 6, further comprising:
assigning bit values to each level of the hierarchical color palette by making the bit value of a color at a higher level in the hierarchical color palette comprise a prefix of the bit values for colors beneath the color at the higher level.

8. The method according to claim 1, further comprising:
selecting at least one level of compression to be applied to the bit values; and
wherein the step of truncating at least one of the bit values comprises truncating at least one of the bit values according to the at least one selected level of compression.

9. The method according to claim 8, further comprising:
generating rate distortion values;
analyzing the generated rate distortion values to determine the level of distortion caused by replacement of a color by a parent color; and
wherein the step of selecting at least one level of compression comprises selecting at least one level of compression to be applied to the bit values based upon the analysis of the rate distortion values.

10. The method according to claim 1, further comprising:
truncating a first set of bit values by a first amount and truncating at least one other bit value by a second amount, wherein the second amount is lower than the first amount.

11. The method according to claim 1, further comprising:
determining whether the palettized image comprises a natural image and a synthetic image; and
selecting a first compression technique for the synthetic image and a second compression technique for the natural image in response to a determination that the palettized image comprises a natural image and a synthetic image, wherein the first compression technique differs from the second compression technique.

12. The method according to claim 11, wherein the second compression technique comprises a lossless compression technique, and wherein the step of truncating at least one of the bit values comprises truncating at least one of the bit values of the synthetic image, the method further comprising:
compressing the natural image using the second compression technique.

13. The method according to claim 1, wherein the palettized image comprises a streaming video, the method further comprising:
receiving frames of the streaming video, wherein the each of the frames comprises a palettized image;
arranging the colors of each of the frames in a palette table in a hierarchical manner to form a hierarchical color palette;
defining bit values for the colors in accordance with the arrangement of the colors, such that, the bit values for substantially close colors are related; and
truncating at least one of the bit values to thereby compress the streaming video.

14. A computing device for compressing a palettized image having colors, said computing device comprising:
a memory storing:
a module for arranging the colors of the palettized image in a hierarchical manner;
a module for defining bit values for the colors in accordance with the hierarchical arrangement of the colors, such that, the bit values for substantially close are colors are related; and
a module for compressing by truncating at least one of the bit values; and
a controller for accessing the memory and controlling the modules, wherein the controller is configured to implement the modules to compress the palettized image.

15. The computing device according to claim 14, wherein the controller is further configured to implement the module for arranging the colors to arrange the colors into a plurality of clusters according to the proximities of the colors to the plurality of clusters and to arrange the clusters in a hierarchical manner, such that, colors in the lower levels of the hierarchy have a greater number of colors as compared to the colors in the higher levels of the hierarchy.

16. The computing device according to claim 14, wherein the controller is further configured to implement the module for arranging the colors to select a number of colors for each level of the hierarchy to correspond to different numbers of bits used to represent entries at each level of the hierarchy, and wherein the controller is further configured to implement the module for defining bit values to assign bit values to each level of the hierarchical color palette by making the bit value of a color at a higher level in the hierarchy comprise a prefix of the bit values for colors beneath the color at the higher level.

17. The computing device according to claim 14, wherein the controller is further configured to implement the module for compressing to truncate at least one of the bit values based upon a selected level of compression for the at least one of the bit values.

18. The computing device according to claim 17, wherein the controller is further configured to implement the module for compressing to generate and analyze rate distortion values to determine the level of distortion caused by replacement of a color by a parent color and to select the level of compression for the at least one of the bit values.

19. The computing device according to claim 14, further comprising:
a classifier configured to classify sections of an image into a first classification and a second classification; and
wherein the controller is further configured to implement the module for compressing to compress the section having the first classification with a lossless compression technique and to compress a hierarchically arranged color palette of the section having the second classification by truncating the bit values representing the colors contained in the hierarchically arranged color palette.

20. The computing device according to claim 14, wherein the controller is further configured to implement the modules to arrange palettized images of frames of streaming video in a hierarchical manner, and to compress each of the hierarchical palettized images by truncating at least one of the bit values representing the colors contained in the hierarchical palettized images.

21. A system for compressing a palettized image, said system comprising:
means for arranging colors in a palette table in a hierarchical manner to form a hierarchical color palette;
means for defining bit values for the colors according to the arrangement of the hierarchical color palette; and
means for compressing at least one of the bit values by truncating at least one of the bit values defining the colors.

22. A computer readable storage medium on which is embedded one or more computer programs, said one or more computer programs implementing a method for compressing a palettized image having colors, said one or more computer programs comprising a set of instructions for:
arranging the colors of the palettized image in a palette table in a hierarchical manner to form a hierarchical color palette;
defining bit values for the colors in accordance with the arrangement of the colors, such that, the bit values for substantially close colors are related; and
truncating at least one of the bit values to thereby compress the palettized image.
